(19) United States
(12) Patent Application Publication
(10) Pub. No.: US 2003/0006131 A1
(43) Pub. Date: Jan. 9, 2003

(54) Method and device for controlling ozone production rate by using dual frequency

(75) Inventors: Seung Hee Han, Seoul (KR); Yeon Hee Lee, Seoul (KR); Gyu Jin Ha, Seoul (KR); In Bae Jung, Seoul (KR); Jang Seop Kim, Seoul (KR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KOREA INSTITUTE OF SCIENCE & TECHNOLOGY, Seoul (KR)

(21) Appl. No.: 10/038,648

(22) Filed: Jan. 8, 2002

(30) Foreign Application Priority Data
Jul. 4, 2001 (KR) 2001-0039808

(51) Int. Cl. C01B 13/10; B01J 19/08; B01J 19/12

(52) U.S. Cl. 204/176

(57) ABSTRACT

An ozone production rate control method and a device using dual frequency in an apparatus employing a silent discharge technique are provided. The method includes the steps of: generating a control signal for controlling the ozone production rate; creating, responsive to the control signal, an adjusted signal having an ON/OFF time ratio adjusted depending on the control signal; producing, responsive to the adjusted signal, a low-frequency pulse and a high-frequency signal; and controlling an ON/OFF time ratio of the high-frequency signal. The device includes an ON/OFF time ratio adjusting unit, a low-frequency pulse oscillation circuit, a high-frequency oscillation circuit, and a multiplier.

### BACKGROUND OF THE INVENTION

1. Field of the Invention

The present invention relates to a method and a device capable of controlling the generation of ozone; and, more particularly, to a method and a device for controlling the ozone production rate by using dual frequency in an ozone generating apparatus that employs a silent discharge technique.

2. Description of the Related Art

Ozone (O₃) has been used for various applications because of its strong oxidization, decolorization, deodorization, and sterilization properties. It is, however, impossible to store ozone under room temperature and atmospheric pressure since it tends to reduce to oxygen (O₂). Thus, in order to use ozone, one has to use an ozone generating apparatus, which uses oxygen or air as a raw material for ozone.

Several methods have been developed for ozone generation, such as a method using ultraviolet rays, a silent discharge method and a method of electrolyzing water, etc. Among these methods, a silent discharge method using high-voltage has been used for a wide variety of industrial applications because it can efficiently produce highly concentrated ozone (See, Siemens W. 1857, Ann. Phy. Chem. 102, 66-122).

As is well known in the art, the silent discharge method uses two metal electrodes with one or both of them insulated with a dielectric material. An AC (alternating current) signal is applied to the electrodes and a discharge is then performed in a space between the metal electrodes while oxygen-containing air passes through the space, thereby transforming some of the oxygen into ozone.

An ozone generator using the silent discharge method can be implemented using various shapes and structures. The most popular structure is a cylindrical structure that employs one or more glass pipes. In this method, each of the glass pipes is installed inside metal cylinders being used as ground electrodes, and the glass pipes are coated on the inside with a metal film to provide a high-voltage electrode. This type of cylindrical ozone generator, however, is too voluminous for practical use, and it does not provide a uniform discharge because of the difficulty of maintaining constant intervals between the glass pipes and metal cylinders. Moreover, the glass pipe used as a dielectric become corroded by ozone generated therein, which causes the dielectric breakdown. To overcome such limitations in the conventional cylindrical ozone generators and to raise concentration of ozone being generated, U.S. Pat. No. 5,759,497 discloses a flat plate type ozone generator using flat plate type ceramic as a dielectric, sometimes referred to as an “Otto-Plate type ozone generator.”

To perform a silent discharge by using various types of ozone generators as discussed above, a high-voltage sine wave signal with a commonly used frequency, e.g., 60 Hz (Hertz), is adopted. It is, however, difficult to raise ozone concentration by using an AC signal at such a frequency. Therefore, an ozone generator using an inverter to generate a mid-range frequency signal of about 1 kHz (kilo-Hertz) has recently been developed.

Nevertheless, it is still difficult to effectively raise the ozone concentration because the high-voltage signal is a sine wave.

There are several methods for controlling the ozone concentration in ozone generating apparatuses, such as changing the voltage level or changing the frequency of the high-voltage signal used in ozone generation, and changing the pulse width. However, owing to the characteristics of the silent discharge, it is considerably difficult to linearly control the ozone concentration by these methods. Specifically, when changing the voltage level of a high-voltage signal applied to an ozone generating apparatus, the ozone concentration is normally increased as the voltage level is increased. However, the relationship between the concentration of ozone generated by the ozone generating apparatus and the voltage level applied to the apparatus is not linear, and the silent discharge can be performed only when the voltage level is equal or above a predetermined level. Therefore, it is very difficult to linearly control the ozone concentration by changing the voltage level of the high-voltage signal.

In instances where the frequency of the high-voltage pulse is changed to control the ozone concentration, optimal efficiency in ozone generation cannot be obtained because of impedances between the ozone generator, the high-frequency inverter, and the high-voltage transformer cannot be matched due to the frequency change. Additionally, in instances where the pulse width of the high-voltage pulse is changed, the ozone concentration stops increasing when the pulse width increases over an optimal pulse width.

### SUMMARY OF THE INVENTION

It is, therefore, an objective of the present invention to provide a method and a device for linearly controlling the ozone production rate by using dual frequency in an ozone generating apparatus that employs a silent discharge technique.

In accordance with one aspect of the present invention, there is provided a method for controlling an ozone production rate of an ozone generator, comprising the steps of: generating a first signal for controlling the ozone production rate; generating a second signal, wherein an ON/OFF time ratio of the second signal is determined according to the first signal; and applying to the ozone generator a high-frequency signal for producing ozone only when the second signal is in an ON state.

In accordance with another aspect of the present invention, there is provided a device for controlling an ozone production rate, comprising: means for generating a first signal for controlling the ozone production rate; means for generating a second signal, wherein an ON/OFF time ratio of the second signal is determined according to the first signal; means for generating a high-frequency signal only when the second signal is in an ON state; and means for generating ozone when the high-frequency signal is applied thereto.

### BRIEF DESCRIPTIONS OF THE DRAWINGS

The above and other objects and features of the present invention will become apparent from the following description of preferred embodiments given in conjunction with the accompanying drawings, in which:

FIG. 1 shows a schematic block diagram of an ozone generating apparatus employing an ozone production rate control device in accordance with the present invention;

FIG. 2 illustrates a block diagram of the ozone production rate control device in accordance with the present invention;

FIGS. 3A and 3B present an ON/OFF time ratio of high-frequency voltage pulse produced in accordance with the present invention; and

FIG. 4 depicts a graph showing an ozone production rate versus a control signal in accordance with the present invention.

### DETAILED DESCRIPTION OF THE PRESENT INVENTION

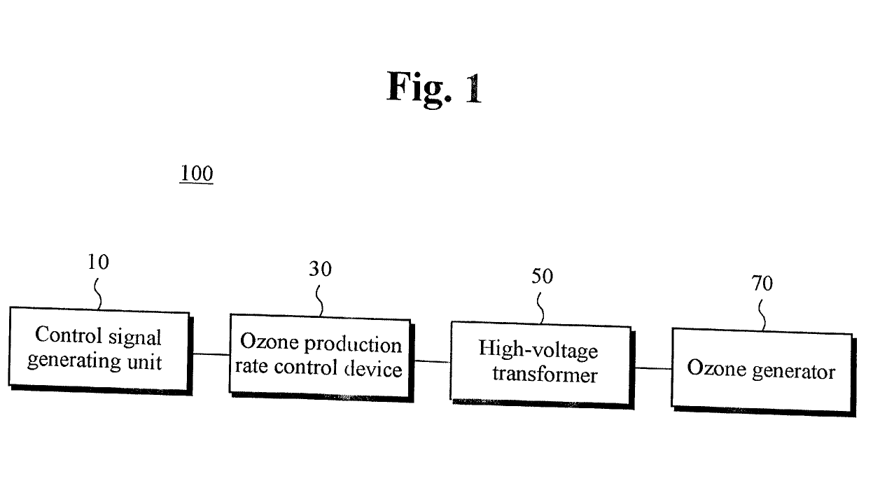

The detailed description of the present invention will be made with reference to FIGS. 1 to 4.

FIG. 1 shows a schematic block diagram of an ozone generating apparatus employing an ozone production rate control device in accordance with the present invention, wherein the ozone generating apparatus employs a silent discharge technique.

As shown in FIG. 1, the ozone generating apparatus 100 includes a control signal generating unit 10, an ozone production rate control device 30, a high-voltage transformer 50, and an ozone generator 70.

The control signal generating unit 10 generates a control signal for controlling the ozone production rate of the ozone generator 70. An input signal to the control signal generating unit 10 is preferably a DC (Direct current) signal with a voltage level ranging from 5 to 10 volts, but is not limited thereto. The ozone production rate control device 30 in accordance with the present invention generates a high-frequency AC (alternating current) pulse with a frequency suitable for a silent discharge. The ozone production rate control device 30 controls the ON/OFF time ratio of the AC pulse according to the ON/OFF time ratio of the control signal. The high-voltage transformer 50 is a step-up transformer and boosts the voltage of the AC pulse from the ozone production rate control device 30 to a high-voltage suitable for the silent discharge. The ozone generator 70 produces ozone through the silent discharge in response to the high-voltage pulse from the high-voltage transformer 50.

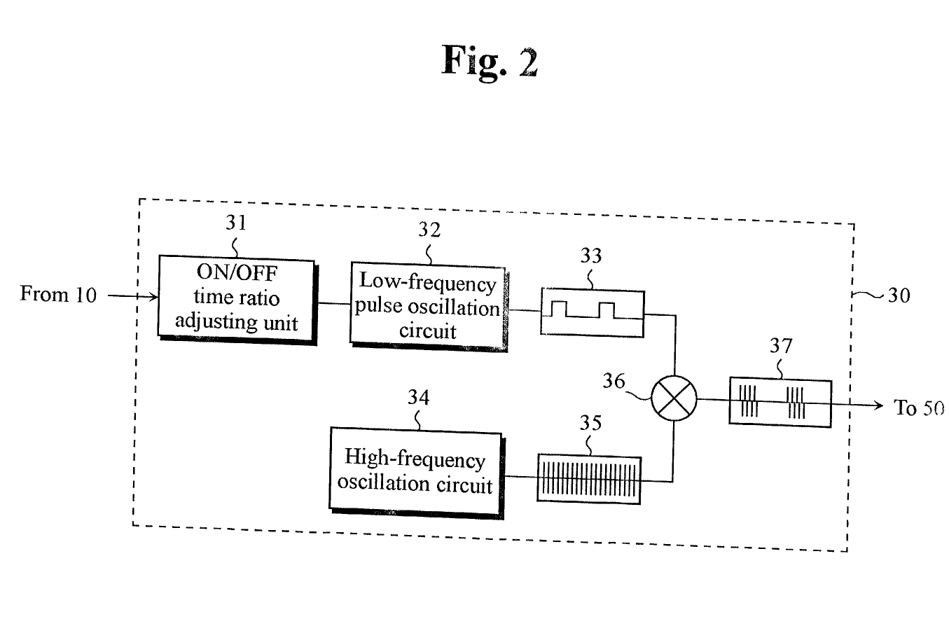

FIG. 2 illustrates a block diagram of the ozone production rate control device 30 in accordance with the present invention. The ozone production rate control device 30 includes an ON/OFF time ratio adjusting unit 31, a low-frequency pulse oscillation circuit 32, a high-frequency signal oscillation circuit 34, and a multiplier 36.

In response to the control signal from the control signal generating unit 10 of FIG. 1, the ON/OFF time ratio adjusting unit 31 generates an adjusted signal having a predetermined ON/OFF time ratio. The low-frequency pulse oscillation circuit 32, which is responsive to the adjusted signal from the ON/OFF time ratio adjusting unit 31, generates a low-frequency pulse 33 having the predetermined ON/OFF time ratio and a frequency ranging from 1 Hz to 5 kHz. The high-frequency signal oscillation circuit 34 generates a high-frequency signal 35 having a frequency ranging from 1 to 50 kHz to be used in the silent discharge. The multiplier 36 multiplies the low-frequency pulse 33 and the high-frequency signal 35 to generate a high-frequency pulse 37 having the predetermined ON/OFF time ratio. The high-frequency pulse 37 is transmitted to the high-voltage transformer 50. Thereafter, the high-voltage transformer 50 boosts the voltage of the high-frequency pulse 37 to a high voltage level. The high-frequency voltage pulse from the high-voltage transformer 50 is applied to the ozone generator 70 of FIG. 1 to be used in the silent discharge.

For example, if a DC signal ranging between 0 V and 5 V is used as the control signal, the adjusted signal from the ON/OFF time ratio adjusting unit 31 to the low-frequency oscillation circuit 32 has an ON/OFF time ratio as follows: in the ON state 0% of the time and in the OFF state 100% of the time when the control signal is 0 V; in the ON state 20% of the time and in the OFF state 80% of the time when the control signal is 1 V; in the ON state 40% of the time and in the OFF state 60% of the time when the control signal is 2 V; in the ON state 60% of the time and in the OFF state 40% of the time when the control signal is 3 V; in the ON state 80% of the time and in the OFF state 20% of the time when the control signal is 4 V; and in the ON state 100% of the time and in the OFF state 0% of the time when the control signal is 5 V. In response to the adjusted signal, the low-frequency pulse oscillation circuit 32 generates a low-frequency pulse having an ON/OFF waveform depending on such time ratio.

Since the ON/OFF time ratio of high-frequency pulse 37 is adjusted according to the control signal from the control signal generating unit 10 as described above, the ozone production rate of the ozone generator 70 is changed accordingly and the ozone concentration can be linearly controlled.

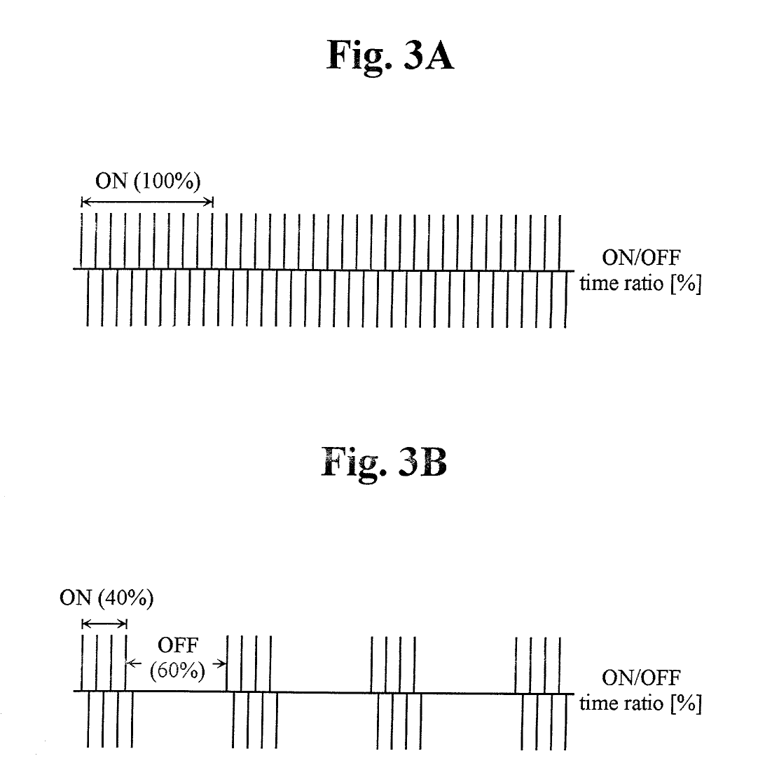

FIGS. 3A and 3B present an ON/OFF time ratio of the high-frequency voltage pulse produced in accordance with the present invention. FIG. 3A illustrates the high-frequency voltage pulse in the ON state 100% of the time. When such a pulse is applied to the ozone generator 70, the silent discharge is continuously performed, thereby obtaining the maximum ozone production rate.

FIG. 3B illustrates the high-frequency voltage pulse in the ON state 40% of the time and in the OFF state 60% of the time. When such a pulse is applied to the ozone generator 70, the ozone production rate is 40% of the maximum ozone production rate.

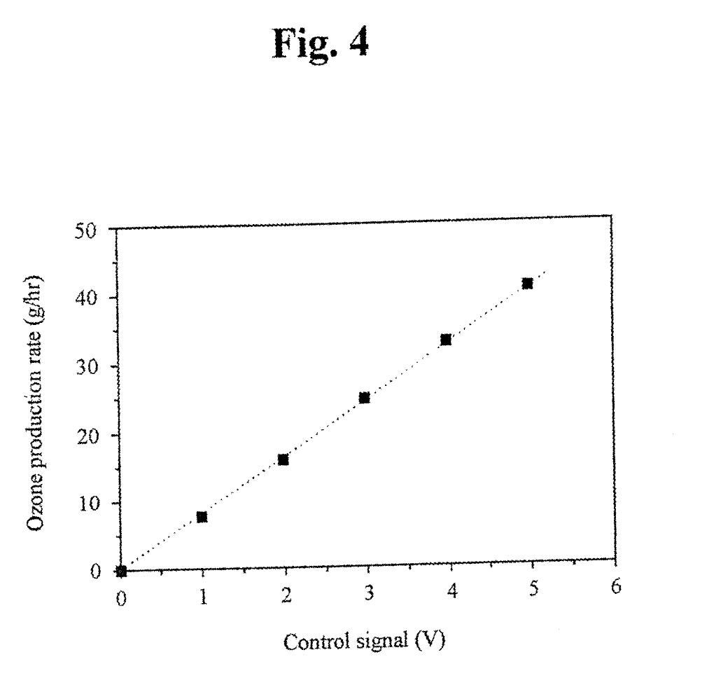

FIG. 4 depicts a graph showing the ozone production rate versus the control signal in accordance with the present invention. The horizontal axis of the graph represents a voltage of the control signal for controlling the ozone production rate, while the vertical axis of the graph represents the ozone production rate. As shown in the graph, the ozone production rate is linearly increased as the control signal increases from 0 V to 5 V.

While the present invention has been described and illustrated with respect to a preferred embodiment of the invention, it will be apparent to those skilled in the art that variations and modifications are possible without deviating from the broad principles and teachings of the present invention which should not be limited solely by the scope of the claims appended hereto.

What is claimed is:

1. A method for controlling an ozone production rate of an ozone generator, comprising the steps of:
generating a first signal for controlling the ozone production rate;
generating a second signal, wherein an ON/OFF time ratio of the second signal is determined according to the first signal; and
applying a high-frequency signal for producing ozone to the ozone generator only when the second signal is at ON state.

2. The method of claim 1, wherein the first signal is a DC (Direct Current) signal with a voltage level ranging from 5 to 10 volts.

3. The method of claim 1, wherein the second signal is a pulse having a frequency ranging from 1 Hz (Hertz) to 5 kHz (kilo-Hertz).

4. The method of claim 1, wherein the high-frequency signal is a pulse having a frequency ranging from 1 kHz to 50 kHz.

5. A device for controlling an ozone production rate, comprising:
means for generating a first signal for controlling the ozone production rate;
means for generating a second signal, wherein an ON/OFF time ratio of the second signal is determined according to the first signal;
means for generating a high-frequency signal only when the second signal is in an ON state; and
means for generating ozone when the high-frequency signal is applied thereto.

6. The device of claim 5, wherein the first signal is a DC.

7. The device of claim 5, wherein the second signal is a pulse having a frequency ranging from 1 Hz to 5 kHz.

8. The device of claim 5, wherein the high-frequency signal is a pulse having a frequency ranging from 1 kHz to 50 kHz.
